(19) United States
(12) Patent Application Publication
(10) Pub. No.: US 2012/0139531 A1
(43) Pub. Date: Jun. 7, 2012

(54) POSITION DETECTING SYSTEM

(75) Inventors: William E. Villano, Canton, CT (US); Kevin Gibbons, Torrington, CT (US)

(73) Assignee: HAMILTON SUNDSTRAND CORPORATION, Windsor Locks, CT (US)

(21) Appl. No.: 12/962,140

(22) Filed: Dec. 7, 2010

(51) Int. Cl. G01B 7/30

(52) U.S. Cl. 324/207.18

(57) ABSTRACT

A position detecting system for a differential movement system which moves a first surface and a second surface from a fixed surface includes an actuation system to move the second surface relative to the first surface and to allow the second surface to move with the first surface; a sensor connected to the actuation system to detect a parameter of the actuation system related to an expected amount of movement of the second surface to determine the expected amount of movement of the second surface; and a sensor system connected to the second surface and the fixed surface to detect the amount of actual movement of the second surface.

### CROSS-REFERENCE TO RELATED APPLICATION(S)

This application is related to U.S. Application Ser. No. ______, titled ACTUATION SYSTEM and filed on Dec. ______, 2010, which is herein incorporated by reference.

### BACKGROUND

Jet engines typically include movable parts, which can be moved outward or retracted at various times through a flight. These movable parts are typically moved through actuation systems of various types.

The thrust reverser system of an engine may include a number of such movable parts. Generally a thrust reverser system includes two thrust reverser doors. The thrust reverser doors are actuated independently, and are located on each side of the engine, one on the right side and one on the left side. Each thrust reverser door assembly may include a variable area fan nozzle (“VAFN”) door which needs to be able to move with the thrust reverser door, and further be able to translate separately from the movement with the thrust reverser door.

Due to the extreme environment of an engine during flight, actuation systems do not always work properly, and can jam. It is necessary to determine when a jam has occurred due to the critical importance certain systems play in flight and during take-off and landing. To combat this sensors are sometimes attached to the moving parts and connected by translating wires to transmit the actual location of the moving part. In the thrust reverser system discussed above, a sensor is sometimes placed on the VAFN door and connected with wires that extend and retract with both the thrust reverser door and the VAFN door movements (whether concerted movements or separate movements).

### SUMMARY

A position detecting system for a differential movement system which moves a first surface and a second surface from a fixed surface includes an actuation system to move the second surface relative to the first surface and to allow the second surface to move with the first surface; a sensor connected to the actuation system to detect a parameter of the actuation system related to an expected amount of movement of the second surface to determine the expected amount of movement of the second surface; and a sensor system connected to the second surface and the fixed surface to detect the amount of actual movement of the second surface.

A method of detecting the position of a first surface and a second surface relative to a fixed surface in a system where the second surface moves with the first surface but can also be moved beyond the movement with the first surface includes actuating one or both of the first surface or the second surface; determining an expected translation amount through a sensor connected to the actuation system of the second surface; detecting an actual translation amount through a sensor system connected to the second surface and to the fixed structure; and comparing the expected translation amount with the actual translation amount.

### BRIEF DESCRIPTION OF THE DRAWINGS

FIG. 1A is a block diagram position detection system according to an embodiment of the current invention with the thrust reverser door closed and the VAFN door closed.

FIG. 1B is a block diagram of the position detection system of FIG. 1A with the thrust reverser door closed and the VAFN door open.

FIG. 1C is a block diagram of the position detection system of FIG. 1A with the thrust reverser door open and the VAFN door open.

FIG. 1D is a block diagram of the position detection system of FIG. 1A with the thrust reverser door open and the VAFN door open.

### DETAILED DESCRIPTION

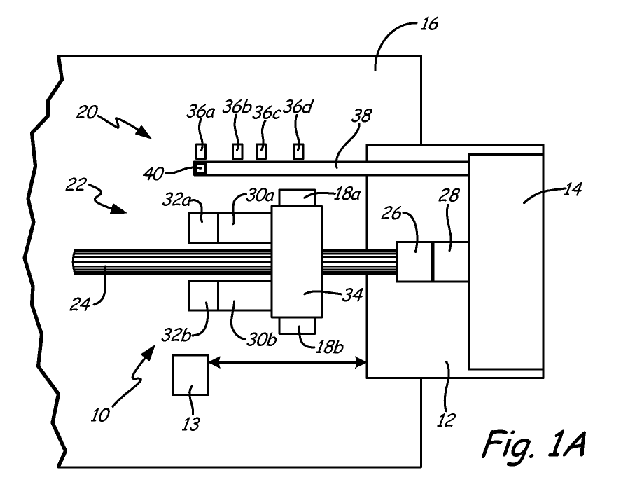

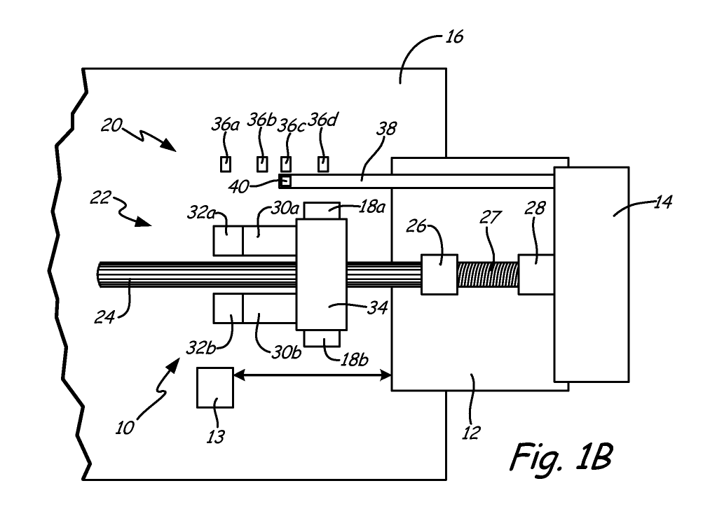

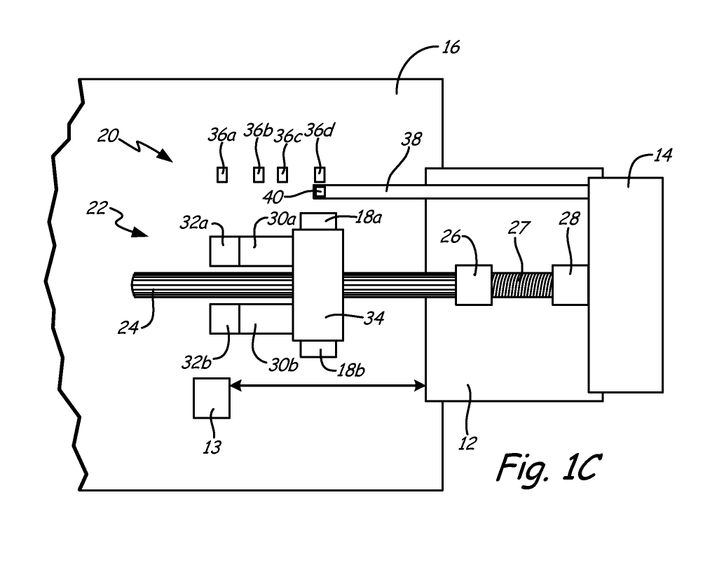

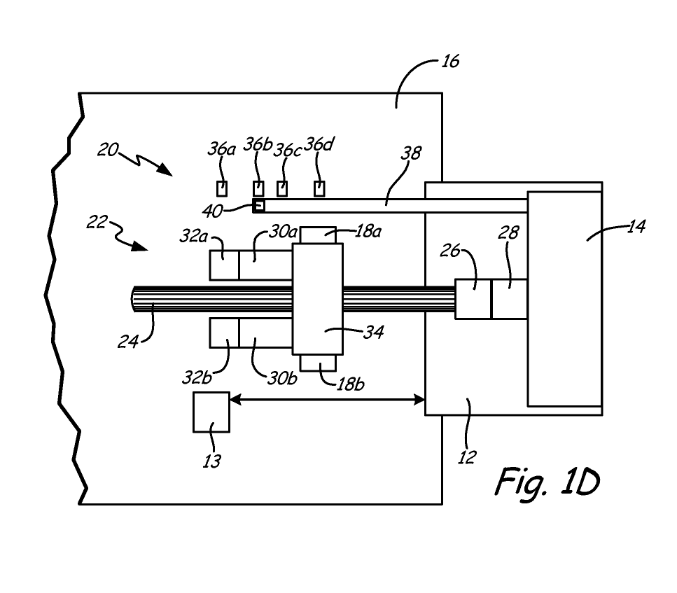

FIG. 1A is a block diagram position detection system for a thrust reverser door assembly according to an embodiment of the current invention where the thrust reverser door and the VAFN door are closed. FIG. 1A represents the thrust reverser door and VAFN door to be actuated on one side of an engine.

FIG. 1A includes actuation system 10, thrust reverser door 12 with thrust reverser door drive unit 13, VAFN door 14, fixed surface 16, rotary variable differential transformers (“RVDTs”) 18a, 18b, and proximity sensor system 20. Actuation system includes drive unit 22, shaft 24, collar 26, ballscrew 27 (FIG. 1B) and ball nut 28. Drive unit 22 includes motors 30a, 30b with brakes 32a, 32b and summing box 34. Proximity sensor system 20 includes proximity sensors 36a, 36b, 36c, 36d and arm 38 with target 40.

Brakes 32a, 32b, motors 30a, 30b, and summing box 34 of drive unit 22 are connected to fixed surface 16, which can be a nacelle. Brakes 32a, 32b are connected to motors 30a, 30b which are connected to summing box 34. Shaft 24 is connected to summing box 34, typically through a splined connection (not shown) or any connection that allows for shaft 24 to be driven by drive unit 22 and also allows shaft 24 to simply move through drive unit 22 when VAFN door 14 is being moved with thrust reverser door 12. Collar 26 is fixed to thrust reverser door 12 and connects to shaft 24. Ballscrew 27 is connected to collar 26 and to ball nut 28, which is connected to VAFN door 14. VAFN door 14 connects to thrust reverser door 12. Thrust reverser door 12 is driven by thrust reverser door drive unit 13. RVDTs 18a, 18b are connected to summing box 34. RVDTs 18a, 18b may represent any type of rotational sensor known in the art. Target 40 can be in arm 38 or attached to arm 38. Target 40 can be a magnet with sensors 36a-36d being proximity magnetic sensors. Arm 38 is connected to VAFN door 14, and proximity sensors 36a, 36b, 36c, 36d are connected to fixed structure 16. Arm 38 can be made integral to VAFN door 14 or can be attached to it through soldering, welding or any other suitable means.

Brakes 32a, 32b work to stop motors 30a, 30b when desired. Motors 30a, 30b connect to summing box 34, which acts as a gearbox, imparting the rotation by one or both of motors 30a, 30b onto shaft 24 when desired. When rotation is imparted to shaft 24 by summing box 34 of drive unit 22, shaft 24 rotates through collar 26, which drives ballscrew 27. Ballscrew 27 drives ball nut 28 to translate the rotational movement of shaft 24 into a linear movement for VAFN door 14. Thrust reverser door 12 moves linearly through thrust reverser door drive unit 13. Because VAFN door 14 is connected to thrust reverser door 12, VAFN door 14 moves with thrust reverser door 12 whenever it is translated. When VAFN door 14 moves as a result of the translation of thrust reverser door 12, summing box 34 (through the splined connection) allows shaft 24 to move left or right through summing box 34. Arm 38 with target 40 moves with VAFN door 14, and target 40 triggers one of proximity sensors 36a, 36b, 36c, 36d depending on the position of door. In this case, target 40 is triggering proximity sensor 36a, associated with the position which target 40 would be at when VAFN door 14 and thrust reverser door 12 are closed. RVDTs 18a, 18b measure the angular rotation of summing box 34 to determine the estimated amount of movement of VAFN door 14 (whether being actuated by drive unit 22 or moving with thrust reverser door 12).

The current invention provides a system where the position of VAFN door 14 can be detected and checked through sensors 18b, 18a and through proximity sensor system 20 to ensure better control and monitoring of moving surfaces. It is essential to know whether actuation systems are working as intended, and to monitor whether VAFN door 14 has actually moved when drive unit 22 attempts to move it (or when thrust reverser door 12 is supposed to move VAFN door 14) due to the criticality of the system to flight operations including at take off and landing. If one or both of VAFN door 14 and thrust reverser door 12 are not able to open, there will be different thrust than if they were both open. Therefore it is essential to know if one or both of thrust reverser door 12 and VAFN door 14 are actually open to be able to mitigate the faults by compensating for the difference in thrust.

Furthermore, rigid arm 38 with target 40 attached to VAFN door 14 allows for actual position detecting of VAFN door 14 without needing wires strung out to VAFN door 14 to accommodate a sensor directly on it as past systems used. The use of proximity sensor system 20 with rigid arm 38 with target 40 and proximity sensors 36a-36d attached to fixed structure 16 can result in a longer lifespan and fewer problems than in a position detecting system which uses wires connecting to VAFN door 14.

In addition, the use of a plurality of position sensors, including RVDTs and proximity sensors to determine the movement of VAFN door 14, provides a thorough system which can cross-check itself to detect actual movement versus expected movement and still detect position when one position sensor (or system) fails. It can also help to determine where a failure started when a failure in the system is detected. For example, if the system is trying to translate VAFN door 14, and RVDTs 18a, 18b measure the proper amount of angular rotation through summing box 34 to actuate VAFN door 14, but proximity sensor system 20 does not detect actual movement of VAFN door 14, it is likely that there is a problem with the connection between the rotating drive summing box 34 and shaft 24, resulting in the lack of actual movement in VAFN door 14. Conversely, the RVDTs 18a, 18b can detect if one or both of motors 30a, 30b are not working to impart rotational movement onto shaft 24 when commanded. If, for example, RVDT 18a detected no angular rotation from motor 30a, the system could mitigate faults by activating brake 32a on motor 30a, and driving shaft 24 only with motor 30b.

FIG. 1B is a block diagram of the position detection system of FIG. 1A with the thrust reverser door closed and the VAFN door open, and includes thrust reverser door 12, VAFN door 14, fixed surface 16, RVDTs 18a, 18b, and proximity sensor system 20 (with proximity sensors 36a, 36b, 36c, 36d and arm 38 with target 40), drive unit 22 (with motors 30a, 30b with brakes 32a, 32b and summing box 34), shaft 24, collar 26, ballscrew 27 and ball nut 28.

FIG. 1B shows target 40 of proximity sensor system 20 triggering proximity sensor 36c. Proximity sensor 36c is positioned at a place on fixed surface 16 to be triggered when VAFN door 14 is open and thrust reverser door 12 is closed. Generally during flight operations VAFN door 14 is opened before thrust reverser door 12 is opened. Therefore, it is ideal to know whether VAFN door 14 has actually opened prior to opening thrust reverser door 12. Whether VAFN door 14 is open is detected by RVDTs 18a, 18b and cross-checked with whether target 40 has triggered proximity sensor 36c.

FIG. 1C is a block diagram of the position detection system of FIG. 1A with thrust reverser door 12 open and the VAFN door 14 open. In this position, target 40 triggers proximity sensor 36d. Thrust reverser door 12 and VAFN door 14 are generally both open in high power operations, such as during take off. These are critical times of flight operations, so it is essential to know that VAFN door 14 has opened, causing target 40 to trigger proximity sensor 36d.

FIG. 1D is a block diagram of the position detection system of FIG. 1A with thrust reverser door 12 open and the VAFN door 14 closed. Target 40 of proximity sensor system 20 triggers proximity sensor 36b in this position. This is a condition not typically used during flight operations, but it is helpful to know if thrust reverser door 12 is open and VAFN door 14 is closed, as that could signal that drive unit 22 is not working properly

In summary, through the use of sensors (RVDTs 18a, 18b) on drive unit 22 and proximity sensor system 20 comprising a plurality of proximity sensors 36a-36d and target 40 attached to rigid arm 38 that is connected to VAFN door 14 in a thrust reverser assembly, the current invention allows for continuous position detecting and cross-checking of VAFN door 14 to determine failures. The early detection of a failure, such as jamming or a drive unit failure allows for mitigation to accommodate any faults detected, thereby causing the least disturbance to flight operations. Rigid arm 38 attached to the VAFN door 14 allows for detection of the actual movement of VAFN door 14 without the complications of translating wires if an electronic position sensor were attached directly to VAFN door 14. RVDTs 18a-18b on drive unit 22 allow for determining the expected position by detecting angular rotation. Together sensors 18a-18b and sensor system 20 work to give information about position, acting as a cross-check on the other's measurements or a back-up system if one fails.

While a thrust reverser assembly including a VAFN door and a thrust reverser door are shown, the invention could be applicable to a number of other systems with movable parts. These systems could include flaps or slats on an aircraft. Furthermore, the instead of the drive system translating the VAFN door linearly, the drive unit could cause rotational movement of VAFN door. An embodiment of that type could further include a cam and a hinge to accommodate the pivoting movement.

While FIGS. 1A-1D show a system with four proximity sensors 36a-36d, more or fewer proximity sensors could be used. For example, in systems where the VAFN door is always actuated before the thrust reverser door, there may only be two proximity sensors to be triggered when thrust reverser door is closed and VAFN door is open or when thrust reverser door is closed and VAFN door is closed.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A position detecting system for a differential movement system which moves a first surface and a second surface from a fixed surface, the system comprising:
an actuation system to move the second surface relative to the first surface and to allow the second surface to move with the first surface;
a sensor connected to the actuation system to detect a parameter of the actuation system related to an expected amount of movement of the second surface to determine the expected amount of movement of the second surface; and
a sensor system connected to the second surface and the fixed surface to detect the amount of actual movement of the second surface.

2. The system of claim 1, wherein the sensor system is a proximity sensor system.

3. The system of claim 2, wherein the sensor system comprises:
a plurality of proximity sensors mounted on the fixed structure; and
a target connected to the second surface to move with the second surface and trigger one or more of the proximity sensors as it moves near to a proximity sensor.

4. The system of claim 3, wherein the target is supported by a rigid arm connected to the second surface.

5. The system of claim 4, wherein the rigid arm is integral to the second surface.

6. The system of claim 3, wherein there are four proximity sensors.

7. The system of claim 6, wherein one proximity sensor is positioned to be triggered when both the first surface and the second surface are in closed positions, one proximity sensor is positioned to be triggered when the first surface is in an open position and the second surface is in a closed position, one proximity sensor is positioned to be triggered when the first surface is in an open position and the second surface is in an open position, and one proximity sensor is position to be triggered when the first surface is in a closed position and the second surface is in an open position.

8. The system of claim 1, wherein the first surface is a thrust reverser door.

9. The system of claim 1, wherein the second surface is a variable area fan nozzle door.

10. The system of claim 1, wherein the actuation system comprises:
a shaft connected to the second surface; and
a drive unit connected to the fixed surface and the shaft to drive the shaft to move the second surface.

11. The system of claim 10, wherein the drive unit comprises a plurality of motors connected to a summing box which connects to the shaft.

12. The system of claim 11, wherein the sensor to detect the expected amount of movement is a rotary variable differential transformer which measures the angular rotation being imparted to the summing box by each motor.

13. The system of claim 1, wherein the second surface is translated linearly by the actuation system.

14. The system of claim 1, wherein the second surface is translated rotationally by the actuation system.

15. A method of detecting the position of a first surface and a second surface relative to a fixed surface in a system where the second surface moves with the first surface but can also be moved beyond the movement with the first surface, the method comprising:
actuating one or both of the first surface or the second surface;
determining an expected translation amount through a sensor connected to the actuation system of the second surface;
detecting an actual translation amount through a sensor system connected to the second surface and to the fixed structure; and
comparing the expected translation amount with the actual translation amount.

16. The method of claim 15, wherein the sensor system is a proximity sensor system.

17. The method of claim 15, wherein the sensor connected to the actuation system detects angular rotation imparted on a shaft connected to the second surface to determine the expected translation amount.

18. A position detecting system to detect the position of a first surface and a second surface relative to a fixed surface in a system where the second surface moves with the first surface but can also be actuated beyond the movement with the first surface, the position detecting system comprising:
a sensor connected to an actuation system for the second surface to determine expected movement of the second surface based on measurement of an actuation system parameter; and
a proximity sensor system with a plurality of proximity sensors mounted to the fixed structure and a target connected to the second surface to trigger a proximity sensor near to the target when the second surface moves to determine actual translation of the second surface.

19. The position detecting system of claim 18, wherein the sensor to determine the expected movement of the second surface is a rotary variable displacement transformer.

20. The position detecting system of claim 18, wherein the first surface is a thrust reverser door and the second surface is a variable area fan nozzle door.
